(19) United States
(12) Patent Application Publication
(10) Pub. No.: US 2025/0016150 A1
(43) Pub. Date: Jan. 9, 2025

(54) DIGITAL USER AUTHENTICATION USING PASSWORD CONTEXT SUBSTRINGS

(71) Applicant: International Business Machines Corporation, Armonk, NY (US)

(72) Inventors: Christopher David Cocklin, Eastbourne (GB); Simon Francis Page, Southampton (GB); Harry Morgan Williams, Bristol (GB); Daniel James Raper, Eastleigh (GB)

(21) Appl. No.: 18/347,624

(22) Filed: Jul. 6, 2023

(51) Int. Cl. H04L 9/40

(52) U.S. Cl. CPC H04L 63/083; H04L 2463/082

(57) ABSTRACT

The present inventive concept provides for a method of digital user authentication using password context substrings. The method includes comparing corresponding context substrings of an incorrect password input and a correct password database entry. A user legitimacy score is generated based, at least in part, on the compared corresponding context substrings, and a variable incorrect password input protocol is implemented based on the generated user legitimacy score.

### BACKGROUND

Exemplary embodiments of the present inventive concept relate to digital user authentication, and more particularly, to digital user authentication using password context substrings.

A login credential (i.e., username/identification number and password) is the most common method of authentication for granting a user access to a digital resource (e.g., website, email account, user profile, application, and/or online service). A user often has a multitude of digital accounts and thus must recall respective login credentials for each of their multitude of digital accounts. While password managers exist, they can present downsides. For example, password managers can involve subscription costs, manual inputs, failure to initialize, and outdated passwords. A user can also have multiple password managers, each with different stored login credentials, and the multiple password managers may themselves require memorized login credentials. In addition, a singular security breach of a password manager can expose numerous if not the entire multitude of the user's login credentials. A digital user authentication policy typically locks a digital account or requires a password reset upon a predetermined number of invalid password attempts. Foresight of this ubiquitously used policy encourages a user to engage in risky reuse of passwords across digital accounts. However, a user is often able to recall at least a partially accurate password for a digital account. Under such circumstances, a user likely has the capacity to recall an accurate password but may fail to do so within the predetermined number of invalid password attempts.

### SUMMARY

Exemplary embodiments of the present inventive concept relate to a method, a computer program product, and a system for digital user authentication using password context substrings.

According to an exemplary embodiment of the present inventive concept, a method of digital user authentication using password context substrings is provided. The method includes comparing corresponding context substrings of an incorrect password input and a correct password database entry. A user legitimacy score is generated based, at least in part, on the compared corresponding context substrings, and a variable incorrect password input protocol is implemented based on the generated user legitimacy score.

According to an exemplary embodiment of the present inventive concept, a computer program product for digital user authentication using password context substrings is provided. The computer program product includes one or more computer-readable storage media and program instructions stored on the one or more non-transitory computer-readable storage media capable of performing a method. The method includes comparing corresponding context substrings of an incorrect password input and a correct password database entry. A user legitimacy score is generated based, at least in part, on the compared corresponding context substrings, and a variable incorrect password input protocol is implemented based on the generated user legitimacy score.

According to an exemplary embodiment of the present inventive concept, a computer system is provided for digital user authentication using password context substrings. The computer system includes one or more computer processors, one or more computer-readable storage media, and program instructions stored on the one or more of the computer-readable storage media for execution by at least one of the one or more processors capable of performing a method. The method includes comparing corresponding context substrings of an incorrect password input and a correct password database entry. A user legitimacy score is generated based, at least in part, on the compared corresponding context substrings, and a variable incorrect password input protocol is implemented based on the generated user legitimacy score.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100 including a digital user authentication using password context substrings program 150, in accordance with an exemplary embodiment of the present inventive concept.

FIG. 2 illustrates a block diagram of components included in the digital user authentication using password context substrings program 150, in accordance with an exemplary embodiment of the present inventive concept.

FIG. 3 illustrates a flowchart of a method of digital user authentication using password context substrings 300, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

As described above, a digital user authentication policy is uniformly applicable and locks a digital account or requires a password reset upon a predetermined number of invalid password attempts. The present inventive concept provides for augmenting digital user authentication using password context substrings. Corresponding context substrings of an incorrect password input and a correct password database entry are compared. A user legitimacy score is generated based, at least in part, on the compared corresponding context substrings, and a variable incorrect password input protocol is implemented based on the generated user legitimacy score. The implemented variable incorrect password input protocol can include changing a quantity of incorrect password inputs allowed before a user account lockout or a required password reset occurs and/or altering additional security measures. Thus, a digital authentication policy can better differentiate between unauthorized login attempts that should prompt digital account lockout and/or password reset sooner and legitimate users that should be granted more attempts.

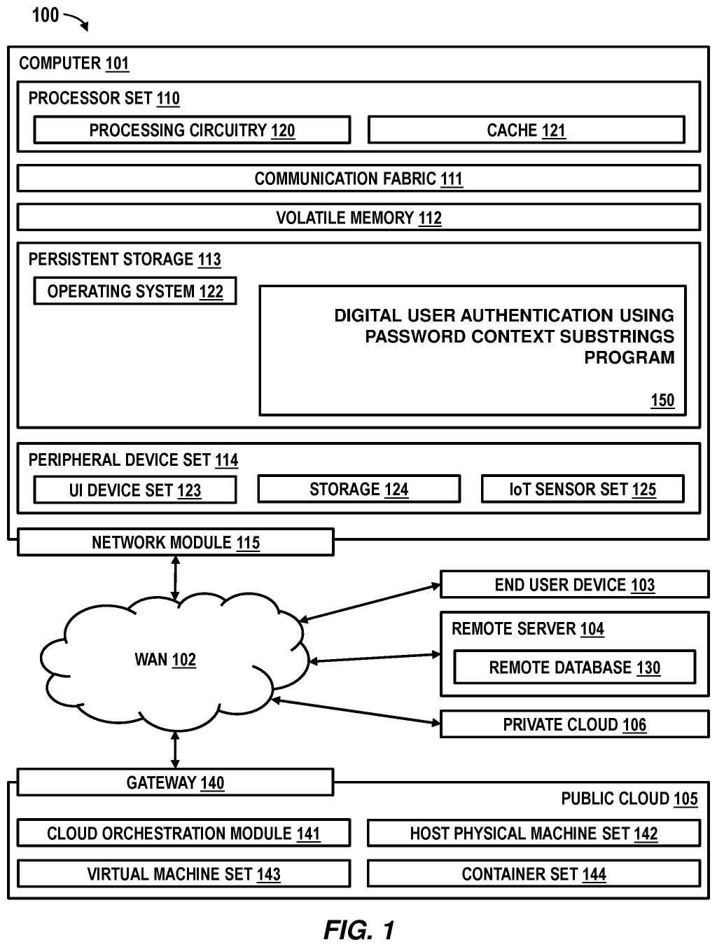

FIG. 1 illustrates a schematic diagram of computing environment 100 including the digital user authentication using password context substrings program 150, in accordance with an exemplary embodiment of the present inventive concept.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the digital user authentication using password context substrings program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

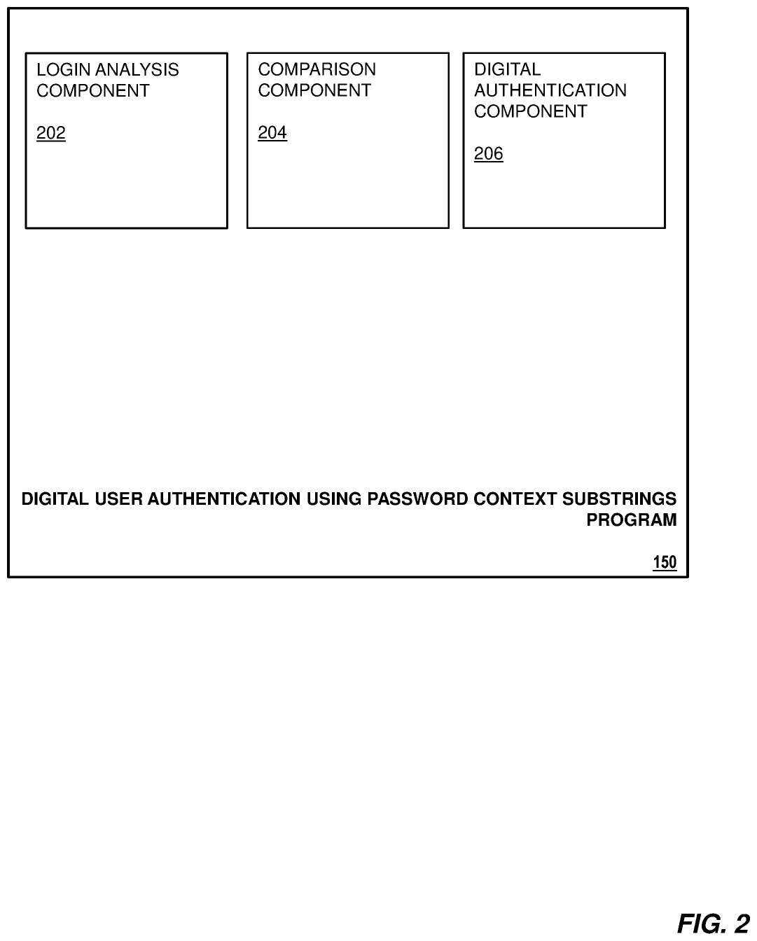

FIG. 2 illustrates a block diagram of components included in the digital user authentication using password context substrings program 150, in accordance with an exemplary embodiment of the present inventive concept.

The digital user authentication using password context substrings program 150 can include a login analysis component 202. The login analysis component 202 can obtain and analyze digital authentication data related to one or more digital accounts for one or more users of one or more digital resources (e.g., websites, email accounts, user profiles, applications, and/or online services, etc.). The digital authentication data can be obtained via a relevant digital authentication data database and/or user inputs. The login analysis component 202 can extract one or more features from the digital authentication data and map them accordingly. The extracted features can include at least one of prior login credential inputs (e.g., correct ID, incorrect ID, correct usernames, incorrect usernames, correct passwords, incorrect passwords, etc.), login history (e.g., time, date, duration between logins, frequency, etc.), login locations (e.g., geographic locations and/or internet protocol (IP) addresses), digital resources, privacy sensitivity of digital resources, login credential input compositions (e.g., constituent characters and positions thereof, character clusters and strengths thereof, words, themes, repetitions, overall strength, complexity, etc.), login credential input patterns (e.g., speed, accuracy, lockout and/or password reset frequencies, predetermined thresholds of occurrence for typos/omissions/additions of characters, character clusters, and/or character positions, password mix-up between digital accounts mutually held by a same user, etc.), and/or incorrect password input thresholds before lockout and/or password reset of the digital resource (i.e., login attempts), etc. The mapped features can be added to a digital authentication database. The login credential inputs (e.g., correct password inputs) can be stored in hash form.

For example, the login analysis component 202 obtains digital authentication data for a social media website, including login credentials for a digital account associated with a user. The login analysis component 202 extracts and maps login features such as a correct username, a correct password input and complexity thereof, incorrect password inputs, prior login gcolocations, internet protocol (IP) addresses, speeds of login credential inputs, a greater than 3-month duration since last login, inclusion of the high strength character cluster “#sWimmer”, inclusion of the low strength character cluster “456” in the overall correct password “J6#sWimmer45690”, and a threshold incorrect password input of 3 attempts for the digital account.

The digital user authentication using password context substrings program 150 can include a comparison component 204. The comparison component 204 can identify a new login attempt (e.g., real-time) and obtain/extract features from corresponding digital authentication data and/or retrieve digital authentication data/features therefor associated with the user and/or digital account. The comparison component 204 can generate a user legitimacy score based, at least in part, on comparing one or more corresponding context substrings of one or more new incorrect password inputs and a stored correct password input (e.g., database entry). The correct context substring can represent a partial correct password input (e.g., a plurality of characters). The constituent characters and positions of the correct context substring can be predetermined by a user, predetermined by character selection rules (e.g., one of each character type, specific character positions, sequences, clusters, intervals, etc.), randomization, and/or based on one or more of the mapped features (e.g., constituent words and/or character clusters, frequently correct/incorrect characters and/or positions thereof, preference for high strength character clusters, etc.). The user legitimacy score can also be based on similarities between extracted features from the newly obtained digital authentication data and the retrieved digital authentication data from the database. The rigor (e.g., complexity, character quantity, character type inclusion, etc.) of the correct context substring can be increased/decreased according to the user legitimacy score (e.g., inverse relationship between rigor and user legitimacy score) and/or one or more predetermined mapped features (e.g., duration since last login, high correct password input complexity, high digital account lockout and/or password reset occurrence, etc.). The correct context substring and/or the user legitimacy score can be stored in the digital authentication database. The correct context substring can be stored as a hash.

For example, the comparison component 204 selects the high strength character cluster “#sWimmer” and the appended character cluster “90” from the correct password as a context substring for the digital account, purposefully excluding the low strength number cluster “456”. The comparison component 204 obtains new incorrect password inputs “J7#sWimmer45690,” “J8#sWimmer45690,” “J9#sWimmer45690” associated with the correct username for the digital account. The comparison component 204 compares the corresponding context substrings of the correct password input and the new incorrect password inputs and determines that only the second character is wrong across login attempts, which is also a pattern identified in the retrieved mapped features for the digital account/user. In addition, the compared geolocations, internet protocol (IP) addresses, and password input speeds match. Moreover, the high strength character cluster “#sWimmer” was accurately input. Thus, the comparison component 204 generates a 90% user legitimacy score.

The digital user authentication using password context substrings program 150 can include a digital authentication component 206. The digital authentication component 206 can implement a variable incorrect password input protocol based on the generated user legitimacy score and/or one or more predetermined mapped features (e.g., privacy sensitivity, duration since last login, password complexity, etc.). The implemented variable incorrect password input protocol can include changing a quantity of incorrect password inputs allowed before a user account lockout and/or a required password reset occurs. A magnitude of the changed quantity of incorrect password inputs allowed can be based on a value of the generated user legitimacy score and/or a spectrum with intervals. In an embodiment, the changed quantity of incorrect password inputs allowed can be increased when the user legitimacy score is at least equal to a predetermined threshold and can be decreased when the user legitimacy score is less than the predetermined threshold. The implemented variable incorrect password protocol can further include an additional security measure, such as requiring at least one of a security question, a two-factor authentication (2FA), a user notification via email or text message, and a captcha.

For example, the digital authentication component 206 allows one additional login attempt for the social media website because the user legitimacy score is over 75% with an additional captcha requirement and allows one further login attempt because the privacy sensitivity for the digital account is below the predetermined threshold, the password complexity exceeds a predetermined threshold, and 3 months or more have elapsed since the last login.

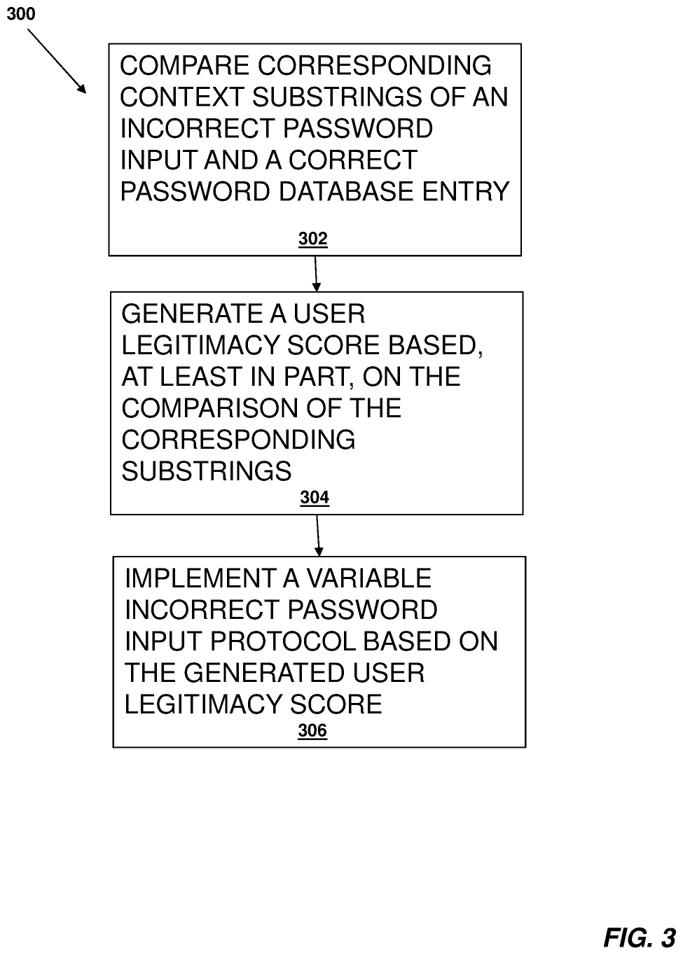

FIG. 3 illustrates a flowchart of digital user authentication using password context substrings 300, in accordance with an exemplary embodiment of the present inventive concept.

The digital user authentication using password context substrings 300 can include steps for:
comparing corresponding context substrings of an incorrect password input and a correct password database entry (step 302);
generating a user legitimacy score based, at least in part, on the compared corresponding context substrings (step 304); and
implementing a variable incorrect password input protocol based on the generated user legitimacy score (step 306).

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

What is claimed is:

1. A method of digital user authentication using password context substrings, the method comprising:
comparing corresponding context substrings of an incorrect password input and a correct password database entry;
generating a user legitimacy score based, at least in part, on the compared corresponding context substrings; and
implementing a variable incorrect password input protocol based on the generated user legitimacy score.

2. The method of claim 1, wherein the implemented variable incorrect password input protocol includes changing a quantity of incorrect password inputs allowed before a user account lockout or a required password reset occurs.

3. The method of claim 2, wherein a magnitude of the changed quantity of incorrect password inputs allowed is based on a value of the generated user legitimacy score.

4. The method of claim 2, wherein the changed quantity of incorrect password inputs allowed is increased when the user legitimacy score is at least equal to a predetermined threshold and is decreased when the user legitimacy score is less than the predetermined threshold.

5. The method of claim 2, wherein the implemented incorrect password protocol further includes at least one of a security question, a two-factor authentication (2FA), a user notification via email or text message, and a captcha.

6. The method of claim 1, wherein the user legitimacy score is further based on at least one of a similarity score of the compared corresponding context substrings, a geolocation, an internet protocol (IP) address, and a speed of at least one incorrect password input.

7. The method of claim 1, wherein the context substring is a predetermined selection of plural characters and respective positions thereof.

8. A computer program product (CPP) for digital user authentication using password context substrings, the CPP comprising:
one or more computer-readable storage media and program instructions stored on the one or more non-transitory computer-readable storage media capable of performing a method, the method comprising:
comparing corresponding context substrings of an incorrect password input and a correct password database entry;
generating a user legitimacy score based, at least in part, on the compared corresponding context substrings; and
implementing a variable incorrect password input protocol based on the generated user legitimacy score.

9. The CPP of claim 8, wherein the implemented variable incorrect password input protocol includes changing a quantity of incorrect password inputs allowed before a user account lockout or a required password reset occurs.

10. The CPP of claim 9, wherein a magnitude of the changed quantity of incorrect password inputs allowed is based on a value of the generated user legitimacy score.

11. The CPP of claim 9, wherein the changed quantity of incorrect password inputs allowed is increased when the user legitimacy score is at least equal to a predetermined threshold and is decreased when the user legitimacy score is less than the predetermined threshold.

12. The CPP of claim 9, wherein the implemented incorrect password protocol further includes at least one of a security question, a two-factor authentication (2FA), a user notification via email or text message, and a captcha.

13. The CPP of claim 8, wherein the user legitimacy score is further based on at least one of a similarity score of the compared corresponding context substrings, a geolocation, an internet protocol (IP) address, and a speed of at least one incorrect password input.

14. The CPP of claim 8, wherein the context substring is a predetermined selection of plural characters and respective positions thereof.

15. A computer system (CS) for digital user authentication using password context substrings, the CS comprising:
one or more computer processors, one or more computer-readable storage media, and program instructions stored on the one or more of the computer-readable storage media for execution by at least one of the one or more processors capable of performing a method, the method comprising:
comparing corresponding context substrings of an incorrect password input and a correct password database entry;
generating a user legitimacy score based, at least in part, on the compared corresponding context substrings; and
implementing a variable incorrect password input protocol based on the generated user legitimacy score.

16. The CS of claim 15, wherein the implemented variable incorrect password input protocol includes changing a quantity of incorrect password inputs allowed before a user account lockout or a required password reset occurs.

17. The CS of claim 16, wherein a magnitude of the changed quantity of incorrect password inputs allowed is based on a value of the generated user legitimacy score.

18. The CS of claim 16, wherein the changed quantity of incorrect password inputs allowed is increased when the user legitimacy score is at least equal to a predetermined threshold and is decreased when the user legitimacy score is less than the predetermined threshold.

19. The CS of claim 16, wherein the implemented incorrect password protocol further includes at least one of a security question, a two-factor authentication (2FA), a user notification via email or text message, and a captcha.

20. The CS of claim 15, wherein the user legitimacy score is further based on at least one of a similarity score of the compared corresponding context substrings, a geolocation, an internet protocol (IP) address, and a speed of at least one incorrect password input.
